(19) United States
(12) Patent Application Publication
(10) Pub. No.: US 2004/0220862 A1
(43) Pub. Date: Nov. 4, 2004

(54) Multiview selective listening system

(76) Inventor: E. T. Jackson, New Castle, DE (US)

Correspondence Address: CONNOLLY BOVE LODGE & HUTZ LLP, SUITE 800, 1990 M STREET NW, WASHINGTON, DC, 20036-3425, US

(21) Appl. No.: 10/753,952

(22) Filed: Jan. 9, 2004

Related U.S. Application Data
(60) Provisional application No. 60/438,791, filed on Jan. 9, 2003.

(51) Int. Cl. G06F 17/60

(52) U.S. Cl. 705/26

(57) ABSTRACT

A system, method and apparatus for selectively listening to a desired entertainment source in public places. The invention allows a customer to comfortably view multiple entertainment sources, such as television sets, while selectively listening to the audio output of a particular entertainment source. In addition, the customer can preset particular audio channels or scan available audio channels to determine programming options that are available.

This application is a Non-Provisional of co-pending Provisional Application Ser. No. 60/438,791 filed on Jan. 9, 2003 by E. T. Jackson, entitled MULTIVIEW SELECTIVE LISTENING SYSTEM, the entire contents of which are incorporated by reference and for which claims priority benefit under Title 35, United States Code § 119(e).

### BACKGROUND OF THE INVENTION

The most common ways for a television (TV) receiver, TV monitor or other display devices to receive TV signals is from broadcasters 1A over the air waves through a local antenna, from cable providers 1B through a coaxial cable or from a satellite provider 1C through a satellite dish, as shown in FIG. 1. In particular, a TV monitor 2 selects a single TV signal channel and separates out a video signal to create the picture and an audio signal to create the sound. The video signal provides a display on a video screen and the audio signal provides sound through speakers of the TV monitor 2 for the viewing and listening pleasure of a viewer.

In a typical Sports Bar setting, there are often as many as 5 to 40 TV receivers or other display devices operating at once with many different programs being viewed. For example, TV monitors 4a-4e are typically clustered or singularly dispersed throughout the area of the Sports Bar, as shown in FIG. 2. However, the sound is usually off or very low on most of these TV receivers to accommodate conversations by patrons of the Sports Bar. Moreover, even if the volume of the sound were turned up on a small number of TV receivers, there would be little intelligible information available to the patrons attempting to listen to a program due to the overlap of the sounds of a number of TV receivers operating at once.

Even with the strategic placement of seating and TV receivers in a Sports Bar to provide patrons with access to many TV programming options for their viewing pleasure, little or no ability to listen to the TV programming of each of the individual TV receivers is available in this environment. In addition, visual or hearing impaired individuals need to be provided with a comfortable way to personalize the level of audio signal provided to them in public places, such as a Sports Bar, for their listening comfort. Thus, a solution that attempts to allow customers in public places to comfortably view and, more particularly, listen to multiple TV or other entertainment sources in public places is needed.

### BRIEF SUMMARY OF THE INVENTION

The present invention allows Sports Bars and similar establishments to display multiple TVs or other display devices without sound so patrons can have the option to both view and selectively listen to any one of the multiple TVs or other entertainment sources available. The invention can be used to retrofit pre-existing establishments that already have multiple TVs or other display devices with the ability to provide their patrons with selective listening capability. The invention allows patrons of an establishment to view those TVs or other display devices available to them and selectively listen to the TV or other entertainment source of their choice. The patrons will be able to move around a specified area without losing the audio signal output of a selected TV or other entertainment source.

One embodiment of the present invention is a system for listening to a selected one of a plurality of entertainment sources comprising: a plurality of entertainment sources, each configured to provide video and audio signal outputs; a plurality of video display devices, each configured to display one of the video signal outputs; a plurality of indicators, each associated with a different one of the plurality of video display devices, each configured to identify a selected one of the video and audio signal outputs; and a plurality of transmitters, each configured to transmit a selected one of a set of carrier frequencies modulated with one of the audio signal outputs for local reception. The modulated carrier frequencies are then demodulated by a plurality of receivers that are used by patrons for selective listening.

Another embodiment of the present invention is a system for listening to a selected one of a plurality of entertainment sources comprising: means for providing video and audio signal outputs from a plurality of entertainment sources; means for displaying the video signal outputs; means for identifying each of the video and audio signal outputs, each associated with a different one of the means for displaying; and means for transmitting carrier frequencies, each modulated with one of the audio signal outputs at a low power level for local reception, said modulated carrier frequencies configured for demodulation by a plurality of receivers for selective listening.

Another embodiment of the present invention is a method for listening to a selected one of a plurality of entertainment sources comprising: receiving video and audio signal outputs from a plurality of entertainment sources; displaying the video signals on a plurality of display devices; identifying each of the video and audio signals by an indicator located on each of the plurality of display devices; modulating carrier frequencies with the audio signal outputs, said modulated carrier frequencies configured for demodulation by a plurality of receivers configured for selective listening; and transmitting the modulated carrier frequencies at a low power level for local reception by the plurality of receivers configured for selective listening.

Another embodiment of the present invention is a Multiple Channel Selector apparatus useful in allowing selective listening to an audio signal associated with one of multiple video sources comprising: at least one tuner configured to separate out audio signal outputs from entertainment signals; and at least one transmitter configured to transmit carrier frequencies modulated with the audio signal outputs at a low power level for local reception, said modulated carrier frequencies configured for demodulation by receivers configured for selective listening.

Another embodiment of the present invention is a Multiple Channel Selector apparatus useful in allowing selective listening to an audio signal associated with one of multiple video sources comprising: means for separating out audio signal outputs from entertainment signals; and means for transmitting carrier frequencies modulated with the audio signal outputs at a low power level for local reception, said modulated carrier frequencies configured for demodulation by a plurality of means for receiving configured for selective listening.

Another embodiment of the present invention is a Patrons band receiver apparatus useful for allowing selective listening to an audio signal associated with one of multiple video sources comprising: an antenna for receiving modulated carrier signals; a tuning section for selecting and for scanning the modulated carrier signals received by the antenna; a demodulator section for signal processing the modulated carrier signals and for producing audio signals; a push button key programming section for identifying audio channel information formats; a microprocessor section for controlling the operation of the PB receiver; and an output section for signal processing the audio signals for selective listening.

In yet another embodiment of the present invention, a Patrons band receiver apparatus useful for allowing selective listening to an audio signal associated with one of multiple video sources comprising: an antenna for receiving modulated carrier signals; a tuning section for selecting and for scanning the modulated carrier signals received by the antenna; a demodulator section for signal processing the modulated carrier signals and for producing audio signals; and an output section for signal processing the audio signals for selective listening.

Yet again another embodiment of the present invention is a method allowing selectable listening, comprising: selecting audio signals from a plurality of entertainment sources; combining a non-audible signal with the audio signal to identify the information format of the entertainment source; modulating each of a plurality of carrier frequencies with a non-audible signal combined with a selected audio signal output from the plurality of entertainment sources; and transmitting the modulated carrier frequencies at a low power level for local reception by a Patrons band receivers.

### BRIEF DESCRIPTION OF THE DRAWINGS

Several embodiments of the invention will now be further described in the following more detailed description of the specification when read with reference to the accompanying drawings in which:

FIG. 1 is an example of various providers of TV and other entertainment source signals;

FIG. 2 is an exemplary configuration of multiple TV receivers typical of a Sports Bar or other entertainment establishment;

FIG. 3 is an exemplary block diagram of a first embodiment of the invention;

FIG. 4a represents an example of a Patrons band (PB) overlaid on the commercial FM band;

FIG. 4b represents another example of the Patrons band overlaid on the FM band;

FIG. 4c shows an example system where the PB channel number is added to the signal sent to the TV receivers or display devices;

FIG. 5a is an exemplary block diagram of a TV receiver with a remote Single Channel Selector Module (SCSM);

FIG. 5b is an exemplary block diagram of a TV receiver with an external Audio Broadcast Unit (ABU);

FIG. 5c is an exemplary block diagram of a TV receiver with an internal Audio Broadcast Unit (ABU);

FIG. 6 is an exemplary block diagram of a Multiple Channel Selector Module (MCSM) configured to support multiple TV receivers within the 150 feet radio coverage area for low power level transmission;

FIG. 7a is an exemplary block diagram of an MCSM;

FIG. 7b is another exemplary block diagram of an MCSM;

FIG. 8 is a chart cross-referencing an exemplary set of preset audio signal channels and the FM radio band;

FIG. 9a is an example of a custom-made PB receiver with preset audio channel scanning capability;

FIG. 9b is an example of a custom-made PB receiver with preset audio channel scanning capability and preset frequency selections;

FIG. 9c is an example of a custom-made PB receiver with preset audio channel scanning capability, preset frequency selections and a menu display device for menu-driven operation;

FIG. 9c is another example of a custom-made PB receiver;

FIG. 9d is yet another example of a custom-made PB receiver;

FIG. 10 is an exemplary block diagram of a PB receiver;

FIG. 11 is another exemplary block diagram of a PB receiver;

FIG. 12 is a timing diagram for the PB receiver of FIG. 11;

FIG. 13 shows an example of a cellular phone equipped with a PB receiver device and headphones; and

FIG. 14 shows individual user with PB receivers variously attached to their bodies and with headsets as they view and selectively listen to programming selections.

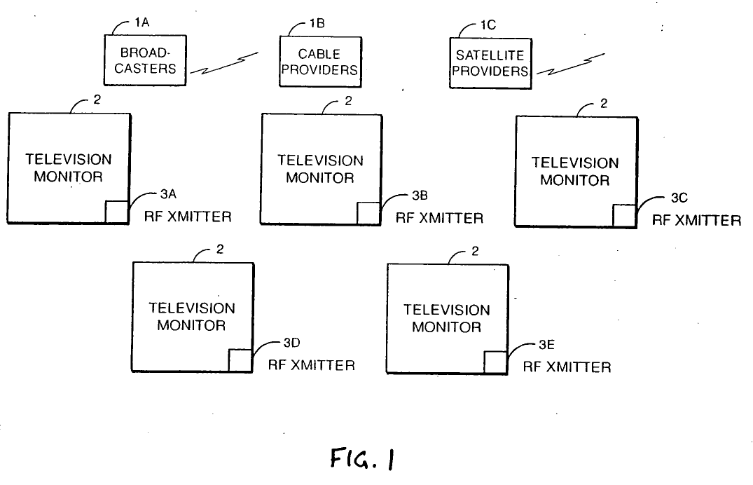

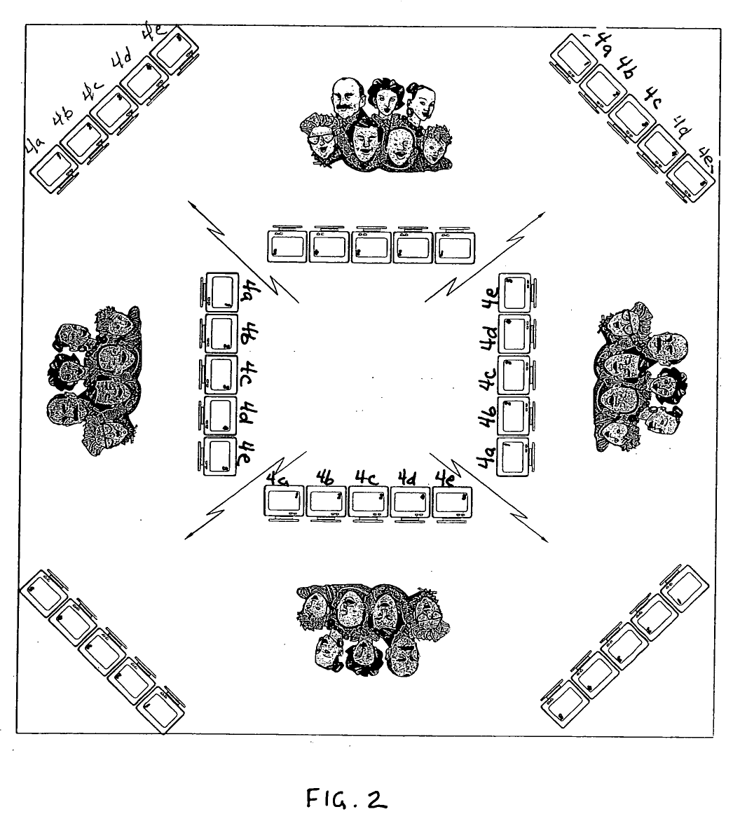

### DETAILED DESCRIPTION OF THE INVENTION

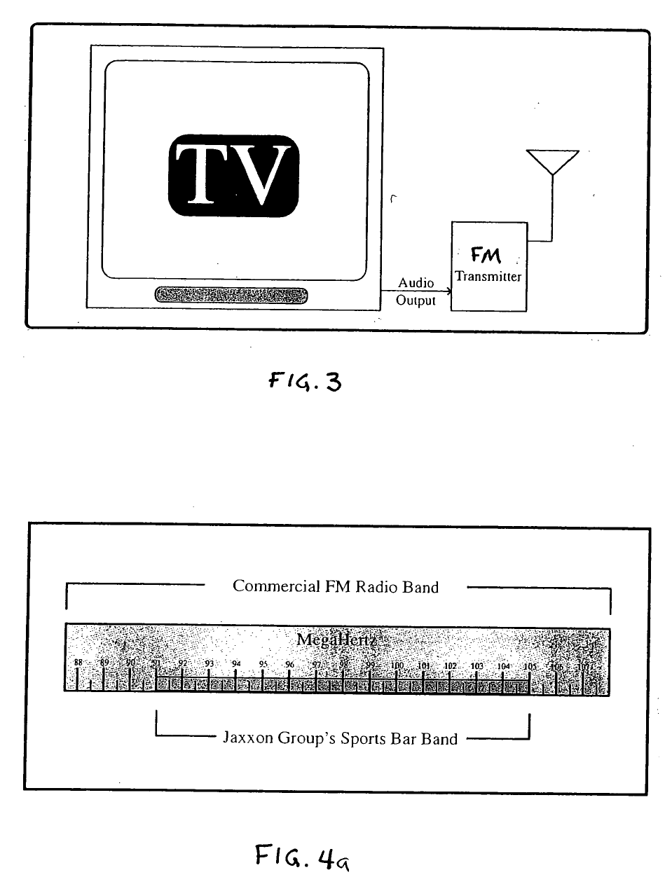

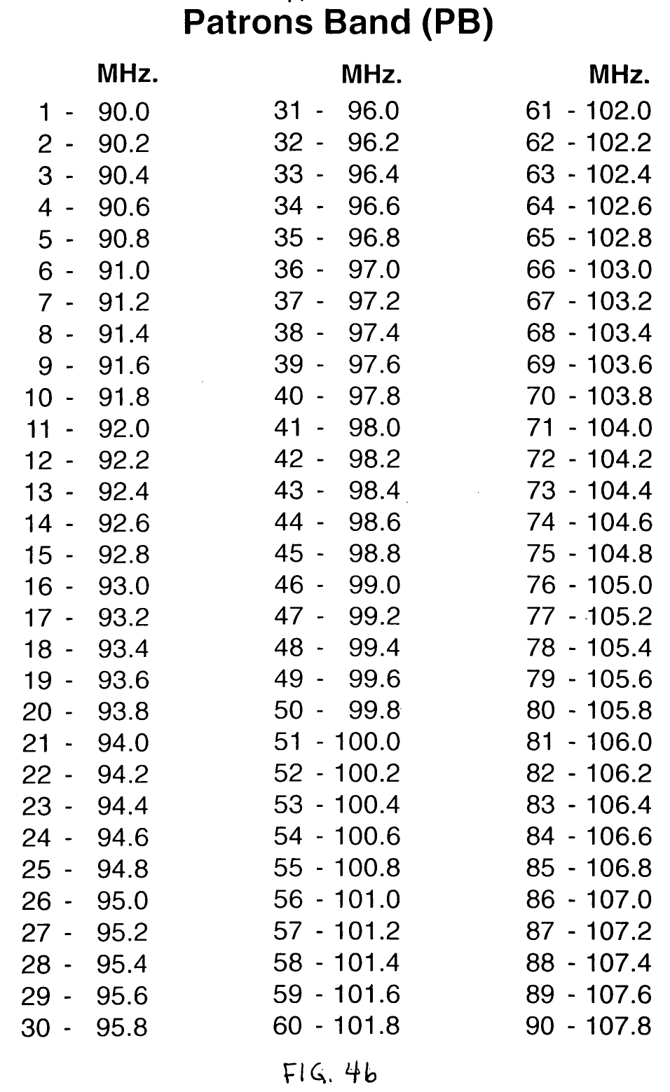

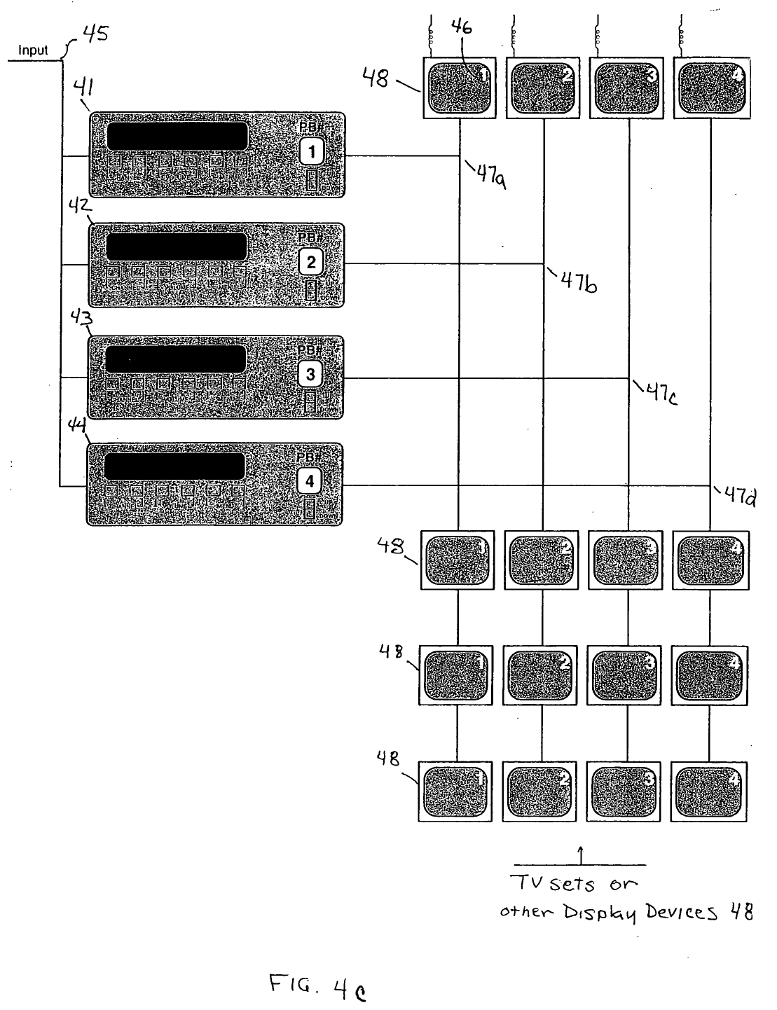

In the present invention an audio signal of a received broadcast radio, broadcast TV, cable television, or satellite television signal is transmitted to patrons by a transmitter that modulates carrier frequencies in the FM band and transmits the modulated carrier frequencies at low power, as shown in FIG. 3. For example, fifteen different carrier frequencies provide a selection of 15 different audio channels for the private listening pleasure of the patrons. In this non-limiting example, the carrier frequencies used could be, for example: 91, 92, 93, 94, 95, 96, 97, 98, 99, 100, 101, 102, 103, 104 and 105 MHz. The carrier frequencies of this example provide good frequency separation between the transmitted FM channels so that reception quality can be maximized. In particular, these 15 carrier frequencies with their 1 MHz separations are an example of a Patrons Band (PB), as is shown in FIG. 4a. The transmitters of the present invention may be for licensed operation or for unlicensed operation, preferably within the limits of the Federal Communication Commissions (FCC). For example, Title 47, Part 15 of the Code of Federal Regulations (CFR) allows low power operation in at least the AM band and FM band without a license. Ordinary AM and FM band receivers or custom-made PB receivers may be used with the invention. As with the example above-discussed, custom-made PB receivers could receive at least 15 preset frequencies of the PB. The preset frequency operation of the custom-made PB receivers allows for efficient frequency scanning through the audio channels so that patrons can quickly review available entertainment source selections.

The present invention provides a facility to broadcast the audio signal portion of one or more TV or other entertainment source signal on a selected carrier for selective listening. For example, the audio signal can be used to frequency modulate a carrier frequency in the FM band, analog modulate a carrier frequency in the AM band or modulate a carrier frequency in another appropriate frequency band (e.g., the Patrons band). The FM band is between 88.1 to 107.9 MHz, as shown in FIG. 4a. Since some TV signals are broadcast at the low end of FM band, the low end frequencies are avoided to prevent radio frequency interference with incoming TV signals. The AM band is between 535 and 1605 KHz. The Patrons band (PB) can be between any two frequencies that provide enough bandwidth to support modulation of multiple carriers with audio signals. The carrier frequencies in one embodiment of the invention may start at 91 MHz and are incremented in equally spaced discrete steps to 105 MHz, as shown in FIG. 4a, to establish the different audio channels that correspond to the audio signals for the TV receivers or other display devices. For example, if the carrier frequencies are incremented in 1 MHz steps, as in FIG. 4a, then 15 different channels are available in the PB for providing audio channels of the TV receivers or other entertainment sources to the patrons. As another example, if the carrier frequencies are incremented in 200 kHz steps, as in FIG. 4b, then 90 different channels are available in the PB for providing audio channels of the TV receivers or other entertainment sources to the patrons.

The audio channel associated with the program of a TV receiver is indicated by placing an audio channel number indicator on the TV receiver or other display device. Thus, all the patron needs to do is tune a receiver to a desired audio channel number to receive the audio signal output of a selected TV receiver or other display device. The receiver may be any of AM, FM and PB receivers that include a headset, earphone or other private listening device to prevent noise and interference between individual patrons listening to different TV or entertainment source selections.

An exemplary system using the invention may consist of three main components: (1) TV receivers or other display devices, (2) a single channel selector module (SCSM), audio broadcast unit (ABU) or a multiple channel selector module (MCSM) and (3) an AM, FM, PB or other appropriate receiver.

TV receivers or other display devices display the video signal. Examples of display devices include TV monitors, computer video display terminals, plasma displays and liquid crystal displays. Each TV receiver or other display device will also have an audio channel indicator to identify the audio frequency channel that contains the audio signal associated with the video signal of the TV receiver or display device. The audio channel indicator may be in the form of a printed sign attached to the TV receiver or display device. Alternatively, the audio channel indicator is a graphic on the video screen of the TV or display device. This graphic may be generated by Picture-in-Picture (PIP) device electronics associated with the TV or display device or by other electronic means. An exemplary technique for generating an audio channel indicator graphic could involve changing the video signal displayed on the TV receivers or display devices by adding additional information to the signal that is sent to the TV receiver or display device. For example, the cable converter boxes 41-44 shown in FIG. 4b could process the input signal 45 and add the PB audio channel indicator 46 as additional information to the signals 47a-47d sent to the TV receivers or display devices 48.

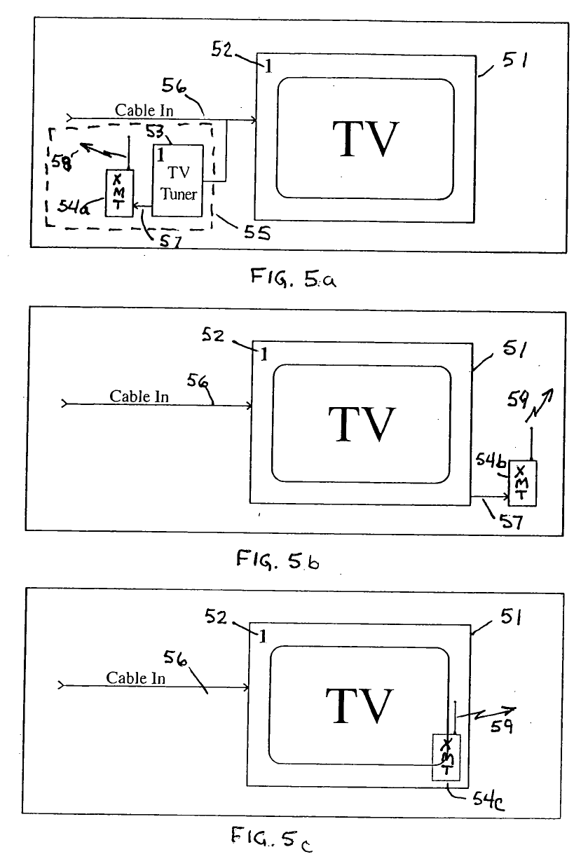

An exemplary system may be configured in a variety of ways. As seen in FIG. 5a, a TV receiver 51 or other display device includes an audio channel indicator 52. The TV receiver 51 can be dispersed strategically in an establishment with a SCSM 55. The SCSM 55 includes a tuner 53 and a low power level modulator/transmitter 54a. The tuner 53 is driven by the signal input to the TV receiver 51 such as a cable input 56. The tuner 53 may have both audio and video outputs. In this embodiment only the audio output 57 is explicitly used. As seen in FIG. 5a, the audio output 57 is coupled to the low power modulator/transmitter 54a. The low power modulator/transmitter 54a can be any suitable modulator/transmitter such as a low power FM transmitter, a low power AM transmitter or another low power modulator/transmitter such as an external modulator/transmitter 54b (e.g., see FIG. 5b) or an internal modulator/transmitter 54c (e.g., see FIG. 5c).

In operation the tuner 53 selects the video channel for reception. The channel selected by the tuner 53 matches the channel to which the TV receiver 51 is tuned (by means not shown). Accordingly, the audio and video outputs of tuner 53 match the audio and video signals selected within the TV receiver 51. The audio signal selected by the tuner 53 is then used as the modulating input for the transmitter 54a. Accordingly, any receiver tuned to the carrier of the transmitter 54a will receive the same audio signal selected by the TV receiver 51 (i.e., the audio signal associated with the video signal displayed on the screen of the TV receiver 51).

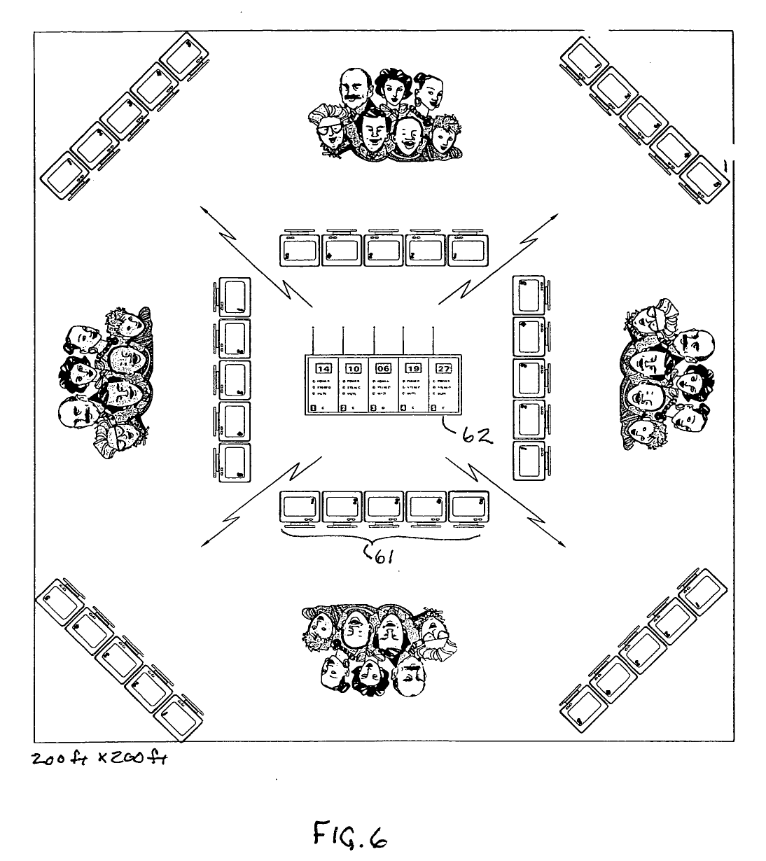

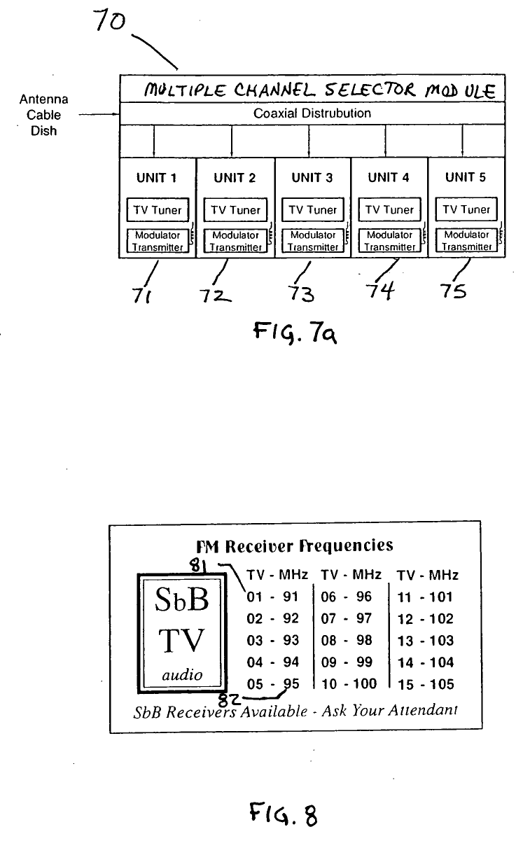

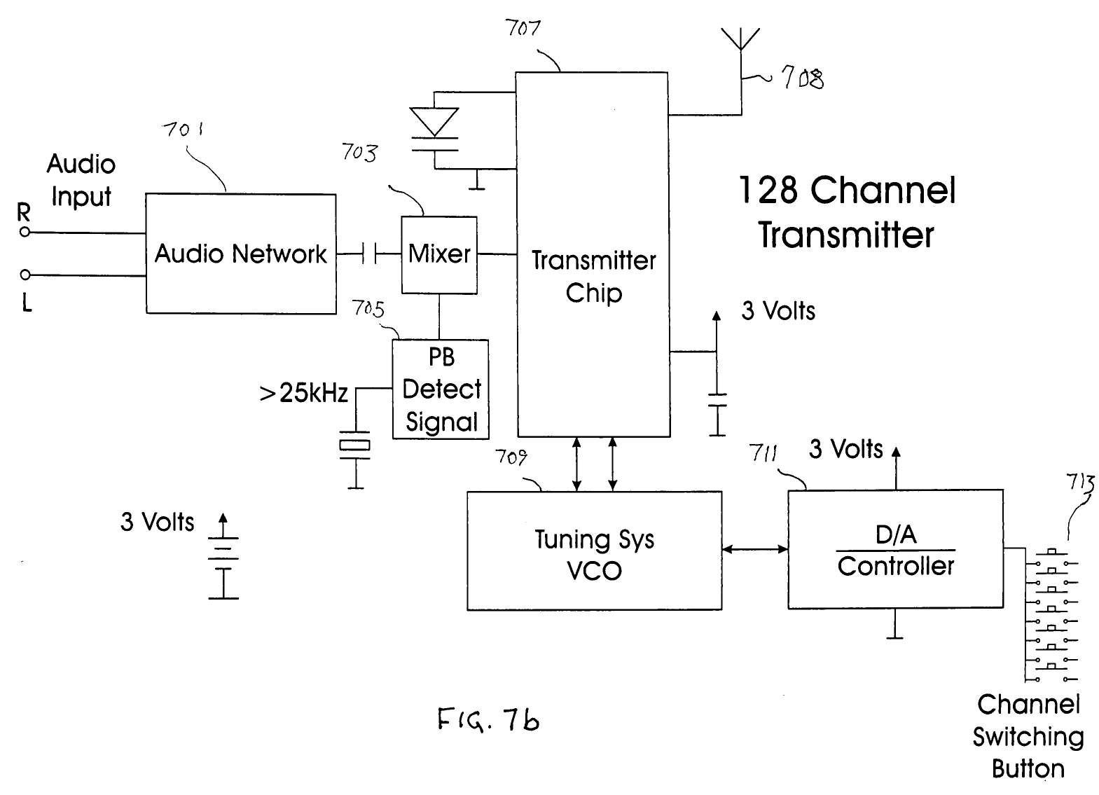

Since, as shown in FIG. 6, most Sports Bars are already configured with clusters or banks of TV receivers or other display devices 61 dispersed throughout the establishment, a Multiple Channel Selector Module (MCSM) will often be configured with TV receivers or other display devices 61. This is because tapping directly into the audio signal outputs at each TV receiver with a modulator/transmitter 54b, 54c, as shown in FIG. 5b and FIG. 5c, respectively, could be impractical in pre-existing entertainment establishments. The MCSM comprises at least one tuner 53 and a low power level modulator/transmitter 54a, as shown in FIG. 5a. Preferably however, the MCSM may also be configured with multiple tuners and modulator/transmitter units 71-75, as shown in FIG. 7a, when associated with clusters or banks of TV receivers or other display devices. Each MCSM operates by (1) receiving multiple TV or entertainment signal inputs, (2) tuning to particular TV or other entertainment source channels, (3) separating out the audio signal from the TV or other entertainment signal inputs, (4) modulating carrier frequencies with audio signal outputs and (5) transmitting low power modulated carrier signals that contain the audio signal outputs of a particular TV or other entertainment source. That is, the MCSM tunes to the desired channels and broadcasts the audio signal at low power to receivers carried by the patrons of the establishment. The low power level carrier frequencies output from the MCSM are such that the audio channel signal is contained within the establishment. In particular, the transmitted low power level modulated carrier frequency signals are available to anyone within approximately 150 feet of an SCSM, ABU or MCSM, as shown in FIG. 7.

FIG. 7b is another exemplary block diagram of an MCSM 700 capable of transmitting 128 channels. An audio input signal is interfaces to an audio network 701 that provides input impedance matching to the MCSM 700. The output of the audio network 701 and PB detect signal 705 are fed to a mixer 703 that provides a frequency shifted version of the audio input signal to a transmitter chip 707. A tuning system voltage controlled oscillator (VCO) 709 provides frequency tuning inputs to the transmitter chip 707 that select the frequency of the RF modulated carrier transmitted by the transmitter antenna 708. The frequency selection input to the tuning system VCO 709 is determined by a D/A controller 711 that converts digital channel switching button inputs 713 to an analog control signal for the VCO 709.

In many applications, the MCSM is provided with an input signal through a single coax cable or, alternatively, multiple coax cables if premium channel boxes are used to select the desired programming. In particular, in the case of premium channels (e.g., HBO, Cinemax, Showtime), the premium channel box is used decode the premium channel entertainment signal and provides an input signal in the TV broadcast band that can be received by the MCSM. The MCSM should be strategically placed somewhere near the center of the operating area of the facility to optimize signal coverage.

As above-discussed, in one embodiment the MCSM is configured to handle five (5) TV or other entertainment source signal inputs and multiple MCSMs can be cascaded to give at least 15 different audio channels for the PB. In addition, if an oversized radio coverage area is required (i.e., larger than the 200 ft.×200 ft. radio coverage area of the low power level AM or FM transmitter), then duplicate MCSMs can be set up to provide for the required wider radio coverage area. The MCSMs can be controlled by remote control. In particular, the tuner channel selection and TV tuner/transmitter unit programming can be done by this remote control.

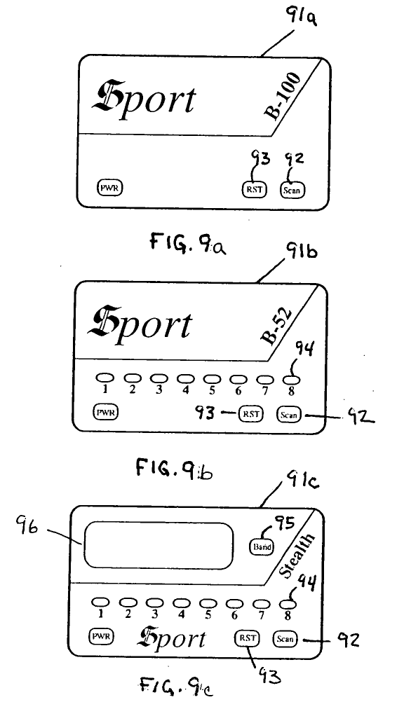

AM band, FM band and PB receivers or cellular phones equipped with PB receiver devices make up the third major component of an exemplary system. In particular, commercial AM band and FM band receivers can be used. In this case, the patron can determine what AM or FM frequency should be used to receive the audio signal outputs of selected TV receivers or other display devices by using a cross-reference chart of the preset audio channel frequencies and the commercial AM and FM band. An example of such a cross-referencing chart showing audio signal channel indicator numbers 81 and their corresponding FM band frequencies 82 is shown in FIG. 8. These cross-referencing charts are made available to the patrons by the establishment.

Referring to FIG. 8, the manner in which the cross-reference chart is constructed is now described. The MSCM has a separate unit, including a tuner and modulator/transmitter for each active TV receiver 1. Let's assume that the unit number and TV receiver number match. Accordingly, unit 1 of the MSCM has its tuner set to receive the same composite TV signal as the TV receiver 1 is tuned to. The tuner extracts the audio signal from the composite TV signal and that audio signal is used to modulate the output of the modulator/transmitter of the unit. As shown in the cross-reference chart, the carrier of the modulator/transmitter of unit 1 is set to 91 MHz. A patron setting an audio receiver to 91 MHz will receive the audio signal associated with the video display on TV receiver 1. In this fashion, the tuner and modulator/transmitter in each other unit of the MSCM is initialized so that the audio carrier frequency in the cross-reference chart carries the audio signal corresponding to the video signal shown on the associated TV receiver.

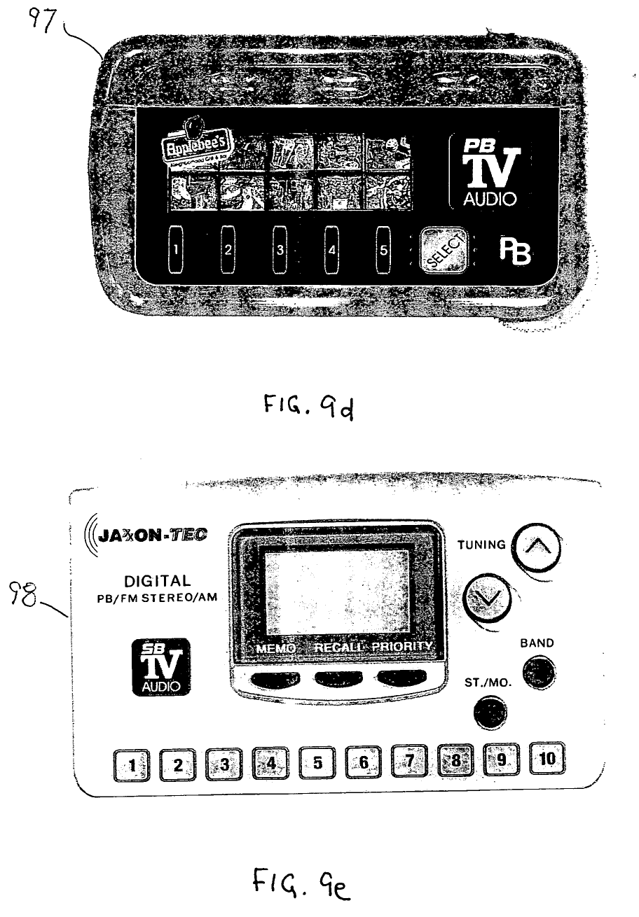

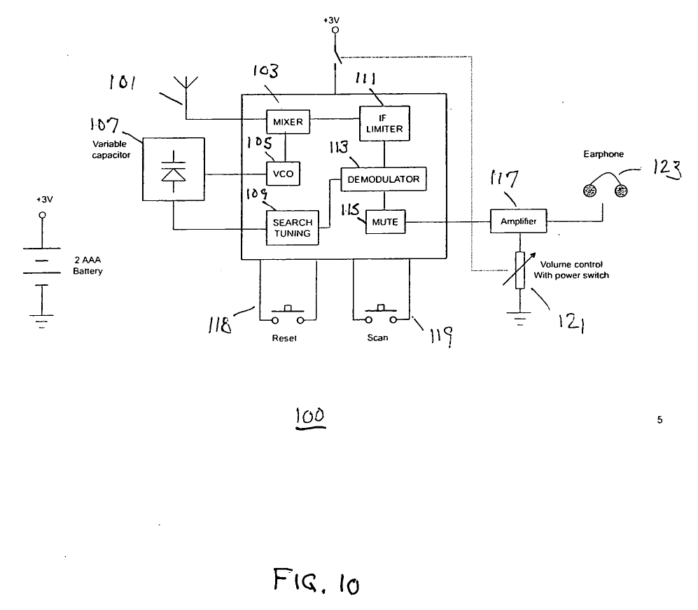

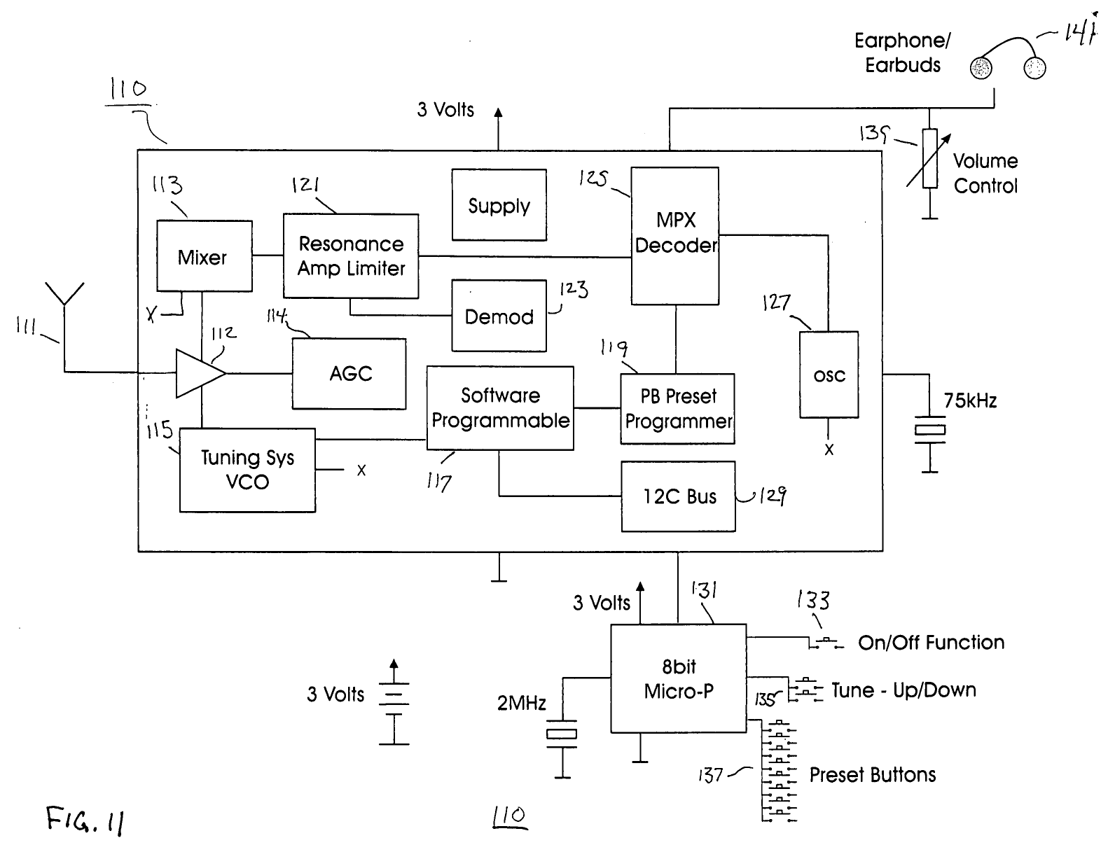

Alternatively, custom-made PB receivers will have means for scanning and selecting preset audio signal channel frequencies. These means for selecting may include discrete buttons, programmable liquid crystal displays, touch-screen panels and other well-known input devices. Exemplary configurations for the custom-made PB receivers are shown in FIG. 9a to FIG. 9e. FIG. 9a shows a basic PB receiver unit 91a with scanning 92 and reset 93 controls only. The scanning frequencies cover the PB preset carrier frequencies. FIG. 9b shows a PB receiver unit 91b that include scanning 92, reset 93 and frequency preset 94 controls. The scanning function covers the PB preset carrier frequencies and at least 8 additional preset frequencies selected by the patron. FIG. 9c shows a PB receiver unit 91c that includes scanning 92, reset 93, frequency preset 94 and frequency band 95 controls as well as a display device 96 for menu driven operation and control. The scanning function covers the PB preset carrier frequencies and at least 8 additional preset frequencies selected by the patron. In addition, other radio frequency bands, such as AM, can be monitored with this receiver. Using the custom-made PB receivers with scanning and preset audio channels provides the capability of scanning the available audio channels for a desired program much easier. FIG. 9d shows a PB receiver unit 97 that has been packaged as a product used at a chain of restaurant establishments. FIG. 9e shows a multi-band receiver unit 98 capable of receiving AM, FM and PB signals.

FIG. 10 shows an exemplary block diagram of PB receiver 100. Antenna 101 receives the RF modulated carrier with the audio input signal. The RF modulated carrier is down converted by mixer 103 to an intermediate frequency (IF) determined by the input to mixer 103 from VCO 105. The frequency of the VCO 105 is tuned by a variable capacitor 107 that is controlled by a search tuning unit 109. The output of the mixer 103 is fed through an IF limiter 111 and on to a demodulator 113. The search tuning unit 109 also provides inputs to the demodulator 113 that select the desired carrier frequency that is to be demodulated. The output of the demodulator 113 is fed through a mute circuit 115 and on to an output amplifier 117. The output amplifier is controlled by a volume control with a power switch 121 that determines the signal to earphones the patron uses to listen to the audio signal. In addition, the PB receiver 100 includes reset 118 and scan 119 control inputs.

FIG. 11 is yet another exemplary block diagram of a PB receiver 110. Antenna 111 receives the RF modulated carrier with the audio input signal. The RF modulated carrier goes through a front end amplifier 112 and has the signal level controlled by an automatic gain control unit 114. The amplified/gain controlled signal is down converted by mixer 113 to an intermediate frequency (IF) determined by the X input to mixer 113 from the tuning system VCO 115. The tuning system VCO 115 also selects the desired carrier frequency that is to be demodulated. The frequency of the VCO 115 is determined by a software programmable unit 117 that is also connected to a PB reset programmer 119 and a digital bus 129. A microprocessor 131 is programmed to provide overall control of the PB receiver 110 through user interfaces for power 133, tuning 135 and channel selection presets 137. The output of the mixer 113 is fed through an IF limiter 121 and on to a demodulator 123. The limiter 121 is also connected to a multiplex decoder 125 that is driven by oscillator 127. The output of the demodulator 123 to an output amplifier. The output amplifier is controlled by a volume control with a power switch 139 that determines the signal to earphones 141 the patron uses to listen to the audio signal.

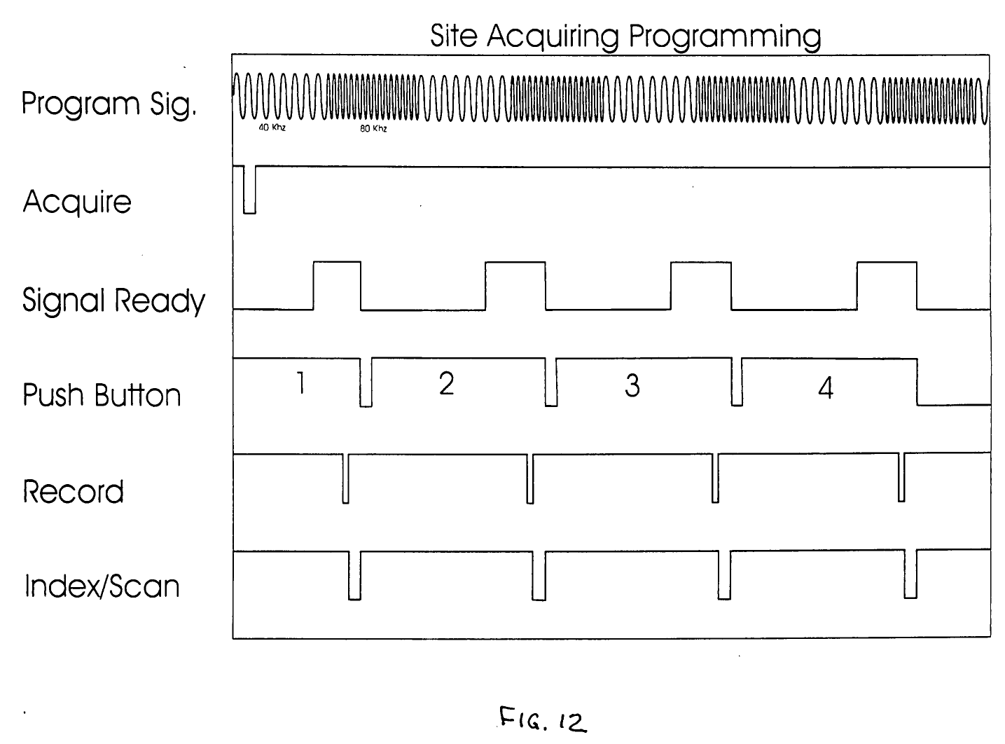

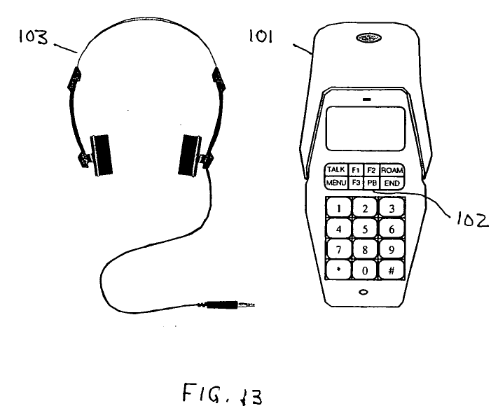

Each Patron band Transmitter mixes a unique non-audible variable frequency signal. A non-limiting example of such a non-audible signal is shown as the “Program Sig.” in FIG. 12. The “Program Sig.” variable frequency signal is out of the audio range (i.e., at 40 kHz/80 kHz) so it will not be heard on the receiver device. This signal is added as a unique detection device to facilitate automatic receiver Push Button Key (PBK) programming for the Patrons band and receivers.

When the PB receiver is turned on or an “Acquire” button is pressed, as indicated by the low level signal output in FIG. 12, the unit starts by programming the lowest preset button (e.g., PB1) with the lowest frequency used in the PB system at which it detects a “Program Sig” of interest that was transmitted by the PB transmitter. Once “Program Sig” is detected, a sample of “Program Sig” is taken during the high level of the “Signal Ready” signal is at a high level to determine the information content, as shown in FIG. 12. If “Program Sig” indicates the audio is a program of interest, a low-level on the “Record” signal which programs the next available push button as indicated by a low-level on the “Push Button” signal, as shown in FIG. 12. At the end of the recording session, the “Index/Scan” signal may direct the PB receiver to index to the next frequency and next preset push button to be programmed. If “Program Sig” is detected is not indicative of a program-of-interest, no preset button is programmed and the next frequency is scanned to determine whether the “Program Sig” meets the requirements of a patron. The process is continued until the frequency span is exhausted or the preset push buttons are all programmed.

With the PBK technique, you can use the same numbering scheme in each facility, for the audio signal channels (e.g., (1-5), (1-10), (1-15)). The lowest signal in the band (i.e., AM, FM or PB) that is used would be assigned channel 1, the second lowest FM signal would be assigned channel 2 and so on. The benefit of the PBK technique is that each site will start with 1 and end with whatever number and the PB receiver will match the site numbering. With the PBK technique, one site could have 5 transmitters starting at 90.0 MHz. and another site could also have 5 transmitters but starting at a different frequency such as 92.4 MHz. Table 1 below shows an example of how the PBK technique numbers the channels in accordance with the lowest frequency detected.

TABLE 1

| | | |
|---|---|---|
| Site 1 | Site 2 | Receiver |

| Tx No. | MHz | Tx No. | MHz | PBK# | MHz |
|---|---|---|---|---|---|
| 1 | 90.0 | 1 | 92.4 | 1 | AUTO |
| 2 | 91.6 | 2 | 93.8 | 2 | AUTO |
| 3 | 92.8 | 3 | 97.2 | 3 | AUTO |
| 4 | 99.0 | 4 | 103.8 | 4 | AUTO |
| 5 | 106.2 | 5 | 107.2 | 5 | AUTO |

Each transmitter transmits a modulated carrier frequency with the audio signal and the higher frequency auto-detect programming signal. The PB receiver programs itself when TURNED ON or when a PROGRAM/ACQUIRE button is pushed. The PB receiver initializes by selecting PBK1 to be the first push button to be programmed and it starts scanning from the lowest channels for the first channel containing the unique programming signal. If there is no signal that matches the profile of the “PROGRAM SIG.,” then it moves on to the next channel. This process is repeated until a signal “PROGRAM SIG.” that matches a desired profile is found. For the PB shown in FIG. 4b, there are 90 channels and if no signal is found, then the PBKs will not be programmed. If a signal is detected in the band that matches the profile, then the first PBK is stored with the recall information for the first channel and then the remaining PBKs are indexed accordingly as the sequential channel scan continues. Each of the starting frequencies would be PBK1, but the PB receiver would reprogram itself to the available frequencies at a site. The process is continued until all the PBKs are programmed or all channels are scanned.

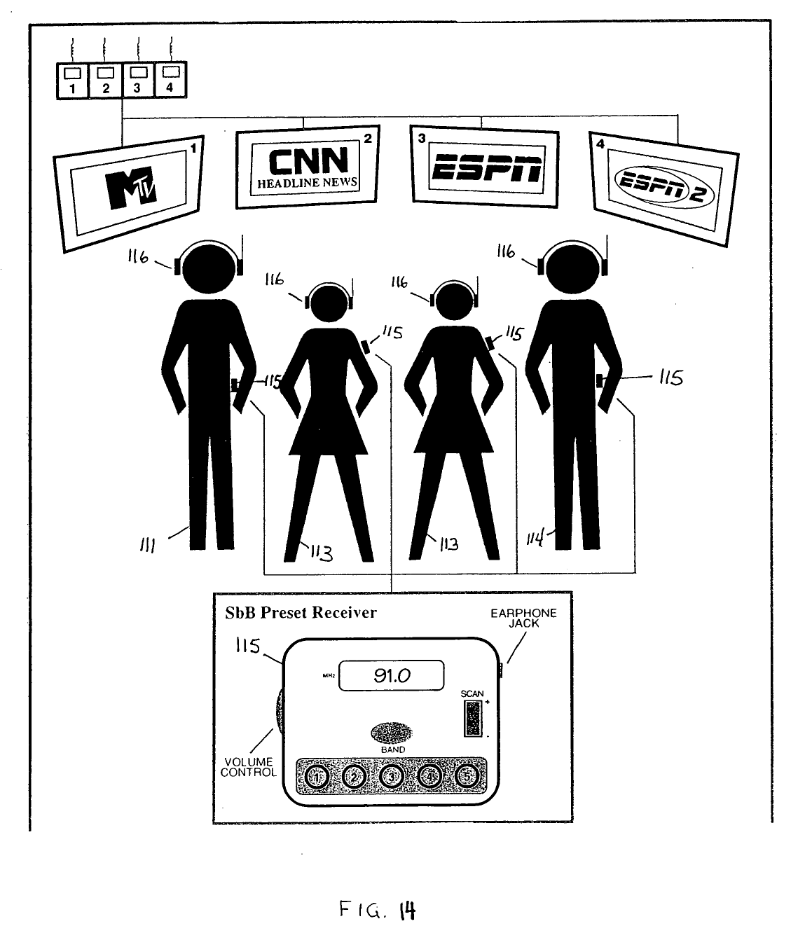

FIG. 13 shows an example of a cellular phone 101 equipped with a PB receiver device. A patron may select a PB function 102 of the cellular phone and a desired PB channel number that would enable the patron to listen to a TV receiver or display device through a headset 103 or other private listening device attached to the cellular phone 101. In addition, Personal Digital Assistants (PDAs), MP3 players and other audio rendering devices could include a PB receiver.

The PB receiver device includes a tuner and a demodulator. The tuner and demodulator are designed in accordance with the parameters of the associated modulator/transmitter of the SCSM, ABU or MCSM. In other words, if the cellular telephone 101 is to cooperate with an AM transmitter then the tuner in the PB device would include a tuner for the AM band and the demodulator would be an AM demodulator. Of course, the PB device could include an FM tuner and FM demodulator or another appropriate tuner and demodulator if desired.

Those skilled in the art are aware that typical cellular telephones use radio frequency carrier modulation and multiplexing schemes such as time division multiple access (TDMA), frequency division multiple access (FDMA) and code division multiple access (CDMA). To the extent there may be an advantage from using the available tuner/demodulator already present in a cellular telephone when used as a PB device, the SCSM, ABU or MSCM can be augmented by including a modulator/transmitter to match the facility in existing cellular telephones. Since some patrons may use a AM or FM radio to receive a particular audio signal and other patrons may wish to use a cellular telephone for that purpose, the SCSM, ABU or MSCM may be modified so that one particular audio signal is modulated both by a AM or FM (or both) modulator/transmitter and the same audio signal is multiplexed using TDMA or CDMA or FDMA. This can be accomplished in at least two different ways. One way involves augmenting a unit (see FIG. 7) so that it has two or more modulator/transmitters, one configured to transmit AM or FM while the other configured to transmit a signal for reception by a cellular telephone. Another way is to have two different units in a SCSM, ABU or MSCM tuned to the same video channel. One of these units transmits an AM or FM audio signal whereas the other unit is configured to transmit a signal for reception by a cellular telephone.

FIG. 11 shows how individual patrons 111-114 may variously attach receivers 115 to their bodies with headphones 116, earphones or other private listening devices for both viewing and selectively listening to available entertainment programming.

In addition to the above-discussed entertainment sources, the present invention can accept programming from a variety of other sources such as a video cassette recorder (VCR), a digital video disc (DVD) player/recorder or a digital camera.

The PB constitutes a frequency span that is used to create a universal, low cost, standardized environment for Multi-channel, Multi-view Selective Listening. The combination of the PB environment and PB receivers creates a system, method and apparatus that yield seamless, individually controlled, quick and easy access to a wireless communication path that is not geographically or site dependent.

The Multi-view Selective Listening System can translate into a standardized protocol that a patron of any establishment would know how to interface with when such a system is encountered. In addition, anyone using a PB receiver or device such as a Personal Digital Assistant (PDA), cellular telephone, MP3 Player or other radio receiving device with audio output that includes the PB system protocol, would be able to receive and utilize the PB system.

The Multi-view Selective Listening System affords individual comfort and control to the user and offers a virtually noise free environment to non-users. In addition, hearing and sight-impaired individuals would benefit by being able to customize their interface with entertainment sources.

The foregoing description of the invention illustrates and describes the present invention. Additionally, the disclosure shows and describes only the preferred embodiments of the invention, but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein. Also, it is intended that the appended claims be construed to include alternative embodiments.

What is claimed as new and desired to be protected by Letters Patent of the United States is:

1. A system for listening to a selected one of a plurality of entertainment sources comprising:
a plurality of entertainment sources, each configured to provide video and audio signal outputs;
a plurality of video display devices, each configured to display one of the video signal outputs;
a plurality of indicators, each associated with a different one of the plurality of video display devices, each configured to identify a selected one of the video and audio signal outputs; and
a plurality of transmitters, each configured to transmit a selected one of a set of carrier frequencies modulated with one of the audio signal outputs for local reception.

2. The system of claim 1, wherein the plurality of entertainment sources are at least one of radio, television receiver, cable, satellite, digital video disc players and video cassette players.

3. The system of claim 1, wherein the plurality of video display devices are at least one of a monitor, a television receiver and a liquid crystal display screen.

4. The system of claim 1, wherein the plurality of indicators are at least one of a printed sign and a graphic on a screen of a video display device.

5. The system of claim 1, wherein the low power level is configured to provide for local reception within an establishment.

6. The system of claim 1, wherein the carrier frequencies are at least in one of an FM band, AM band and Patrons band.

7. The system of claim 6, wherein the carrier frequencies are spaced across at least one of the FM band, AM band and Patrons band.

8. The system of claim 1, wherein the modulated carrier frequencies are selected to be received by at least one of an FM radio, an AM radio, a Patrons band (PB) receiver, and a cellular phone equipped with a PB receiver device.

9. The system of claim 8, which further includes at least one PB receiver, said PB receiver further comprising:
a tuner configured to scan the modulated carrier frequencies; and
a receiver configured to demodulate the modulated carrier frequencies.

10. The system of claim 9, wherein the PB receiver, said PB receiver further comprising:
an interface configured to output the demodulated audio; and
a display device configured to provide means for operating the PB receiver.

11. A system for listening to a selected one of a plurality of entertainment sources comprising:
means for providing video and audio signal outputs from a plurality of entertainment sources;
means for displaying the video signal outputs;
means for identifying each of the video and audio signal outputs, each associated with a different one of the means for displaying; and
means for transmitting carrier frequencies, each modulated with one of the audio signal outputs at a low power level for local reception, said modulated carrier frequencies configured for demodulation by a plurality of receivers for selective listening.

12. The system of claim 11, wherein the plurality of entertainment sources are at least one of broadcast radio, broadcast television, cable television, satellite television, digital video disc players and video cassette players.

13. The system of claim 11, wherein the plurality of video display devices are at least one of a monitor, a television receiver and a liquid crystal display screen.

14. The system of claim 11, wherein the plurality of indicators are at least one of a printed sign and a graphic on a screen of each of the plurality of video display devices.

15. The system of claim 11, wherein the low power level is configured to provide for local reception within an establishment.

16. The system of claim 11, wherein the carrier frequencies are at least in one of an FM band, AM band and Patrons band.

17. The system of claim 16, wherein the carrier frequencies are spaced across at least one of the FM band, AM band and Patrons band.

18. The system of claim 11, wherein the modulated carrier frequencies are received by at least one of an FM radio, an AM radio, a Patrons band (PB) receiver and a cellular phone equipped with a PB receiver device.

19. The system of claim 18, which further includes at least one PB receiver, said PB receiver further comprising:
means for scanning the modulated carrier frequencies; and
means for demodulating the modulated carrier frequencies.

20. The system of claim 19, wherein the PB receiver further comprises:
means for outputting the demodulated audio; and
means for operating the PB receiver through a display device.

21. A method for listening to a selected one of a plurality of entertainment sources comprising:
receiving video and audio signal outputs from a plurality of entertainment sources;
displaying the video signals on a plurality of display devices;
identifying each of the video and audio signals by an indicator located on each of the plurality of display devices;
modulating carrier frequencies with the audio signal outputs, said modulated carrier frequencies configured for demodulation by a plurality of receivers configured for selective listening; and
transmitting the modulated carrier frequencies at a low power level for local reception by the plurality of receivers configured for selective listening.

22. The method of claim 21, wherein the plurality of entertainment sources are at least one of broadcast radio, broadcast television, cable television, satellite television, digital video disc player and video cassette player.

23. The method of claim 21, wherein the plurality of video display devices is at least one of a monitor, a television receiver and a liquid crystal display screen.

24. The method of claim 21, wherein the plurality of indicators is at least one of a printed sign and a graphic on a screen of a video display device.

25. The method of claim 21, wherein the low power level is configured to provide for local reception within an establishment.

26. The method of claim 21, wherein the carrier frequencies are at least in one of an FM band, AM band and Patrons band.

27. The method of claim 26, wherein the carrier frequencies spaced across at least one of the FM band, AM band and Patrons band.

28. The method of claim 21, wherein the modulated carrier frequencies are received by at least one of an FM radio, an AM radio, a Patrons band (PB) receiver and a cellular phone equipped with a PB receiver device.

29. The method of claim 28, which further includes a PB receiver, said PB receiver further comprising:
means for scanning the modulated carrier frequencies; and
means for demodulating the modulated carrier frequencies.

30. The method of claim 29, wherein the PB receiver further comprises:
means for outputting the demodulated audio; and
means for operating the PB receiver through a display device.

31. A Multiple Channel Selector apparatus useful in allowing selective listening to an audio signal associated with one of multiple video sources comprising:
at least one tuner configured to separate out audio signal outputs from entertainment signals; and
at least one transmitter configured to transmit carrier frequencies modulated with the audio signal outputs at a low power level for local reception, said modulated carrier frequencies configured for demodulation by receivers configured for selective listening.

32. A Multiple Channel Selector apparatus useful in allowing selective listening to an audio signal associated with one of multiple video sources comprising:
means for separating out audio signal outputs from entertainment signals; and
means for transmitting carrier frequencies modulated with the audio signal outputs at a low power level for local reception, said modulated carrier frequencies configured for demodulation by a plurality of means for receiving configured for selective listening.

33. A Patrons band receiver apparatus useful for allowing selective listening to an audio signal associated with one of multiple video sources comprising:
an antenna for receiving modulated carrier signals;
a tuning section for selecting and for scanning the modulated carrier signals received by the antenna;
a demodulator section for signal processing the modulated carrier signals and for producing audio signals; and
an output section for signal processing the audio signals for selective listening.

34. The Patrons band receiver of claim 33, wherein the tuning section further comprises a mixer, a voltage controlled oscillator, a variable capacitor and a search tuning section.

35. The Patrons band receiver of claim 33, wherein the demodulator section further comprises an intermediate frequency section for filtering and limiting modulated carrier signals and a demodulator for demodulating the output of the intermediate frequency section.

36. The Patrons band receiver of claim 33, wherein the output section further comprises an amplifier, muting section, volume control and power switch.

37. A Patrons band receiver apparatus useful for allowing selective listening to an audio signal associated with one of multiple video sources comprising:
an antenna for receiving modulated carrier signals;
a tuning section for selecting and for scanning the modulated carrier signals received by the antenna;
a demodulator section for signal processing the modulated carrier signals and for producing audio signals;
a push button key programming section for identifying audio channel information formats;
a microprocessor section for controlling the operation of the PB receiver; and
an output section for signal processing the audio signals for selective listening.

38. The Patrons band receiver of claim 37, wherein the tuning section further comprises a front-end amplifier, mixer, a tuning system voltage controlled oscillator, and an automatic gain control section.

39. The Patrons band receiver of claim 37, wherein the demodulator section further comprises an intermediate frequency section for filtering and limiting modulated carrier signals and a demodulator for demodulating the output of the intermediate frequency section.

40. The Patrons band receiver of claim 37, wherein the pushbutton key programming section further comprises a multiplex decoder and an oscillator;

41. The Patrons band receiver of claim 37, wherein the microprocessor section further comprises software programmable memory, a pushbutton key preset programming section, a digital communications bus, and a microprocessor for interfacing to input control signals.

42. The Patrons band receiver of claim 37, wherein the output section further comprises an amplifier, muting section, volume control and power switch.

43. A method allowing selectable listening, comprising:
selecting audio signals from a plurality of entertainment sources;
combining a non-audible signal with the audio signal to identify the information format of the entertainment source;
modulating each of a plurality of carrier frequencies with a non-audible signal combined with a selected audio signal output from the plurality of entertainment sources; and
transmitting the modulated carrier frequencies at a low power level for local reception by a Patrons band receivers.

44. The method of claim 43 and further comprising:
receiving the modulated carrier frequencies;
demodulating non-audible signals combined with selected audio signal outputs; and
selecting audio signals that have a desired information format as preset channels for the Patrons band receiver, wherein the desired information format is indicated by the non-audible signal.

45. The method of claim 43, wherein the non-audible signal further comprises multiple tones with frequencies of at least 30 kHz.
